(19) United States
(12) Patent Application Publication
(10) Pub. No.: US 2012/0235481 A1
(43) Pub. Date: Sep. 20, 2012

(54) Storage Unit and Power Generation System

(75) Inventors: Takeshi Nakashima, Osaka (JP); Ken YAMADA, Osaka (JP); Hayato IKEBE, Osaka (JP); Ryuzo HAGIHARA, Osaka (JP)

(73) Assignee: SANYO ELECTRIC CO., LTD., Moriguchi-shi, Osaka (JP)

(21) Appl. No.: 13/485,096

(22) Filed: May 31, 2012

Related U.S. Application Data
(63) Continuation of application No. PCT/JP2010/071558, filed on Dec. 2, 2010.

(30) Foreign Application Priority Data
Dec. 4, 2009 (JP) 2009-276103

(51) Int. Cl. H02J 3/00; H01M 2/12; H02J 7/00; H01M 10/50

(52) U.S. Cl. 307/26; 429/120; 429/82; 320/137

(57) ABSTRACT

This storage unit includes a power converter that radiates heat by converting power to direct current or alternating current, a storage portion that stores power, a housing that houses at least the storage portion and the power converter, and an air blower provided in the housing, while the air blower is so configured as to send air containing the heat radiated from the power converter into the housing where the storage portion is arranged.

### CROSS-REFERENCE TO RELATED APPLICATIONS

The priority application number JP2009-276103, Storage Unit and Power Generation System, Dec. 4, 2009, Takeshi Nakashima et al., upon which this patent application is based is hereby incorporated by reference. This application is a continuation of PCT/JP2010/071558, Storage Unit and Power Generation System, Dec. 2, 2010, Takeshi Nakashima, Ken Yamada, Hayato Ikebe, and Ryuzo Hagihara.

### BACKGROUND OF THE INVENTION

1. Field of the Invention

The present invention relates to a storage unit and a power generation system, and more particularly, it relates to a storage unit and a power generation system each including a storage portion capable of storing power.

2. Description of the Background Art

A power generation system including a storage battery capable of storing power is known in general, as disclosed in Japanese Patent Laying-Open No. 11-127546 (1999), for example.

In this power generation system, a photovoltaic power generation module is interconnected to a power grid. The photovoltaic power generation module is connected with the storage battery capable of storing power generated by the photovoltaic power generation module. Furthermore, Japanese Patent Laying-Open No. 11-127546 discloses that the storage battery is so configured as to be capable of being charged also from the power grid, and the storage battery is charged from the power grid in the middle of the night when electricity cost is lower.

In a power generation system including a storage battery, the storage battery may be placed outdoors. It is generally known that the charging performance of the storage battery is degraded significantly in a prescribed temperature range or below, and the storage battery cannot be sufficiently charged. Therefore, if the storage battery of this power generation system is placed outdoors, the temperature of the storage battery decreases in winter, for example, so that it may be difficult to sufficiently charge the storage battery. Furthermore, the air temperature decreases significantly in the middle of the night in winter, and the temperature of the storage battery easily falls below the prescribed temperature range, whereby it is difficult to charge the storage battery in the middle of the night.

### SUMMARY OF THE INVENTION

The present invention has been proposed in order to solve the aforementioned problems, and an object of the present invention is to provide a storage unit and a power generation system each capable of sufficiently charging a storage portion even if the storage portion is placed in an environment where the air temperature may decrease significantly.

A storage unit according to a first aspect of the present invention includes a power converter that radiates heat by converting power to direct current or alternating current, a storage portion that stores power, a housing that houses at least the storage portion and the power converter, an air blower provided in the housing, and a box-shaped power conversion unit that houses the power converter, arranged inside the housing, while the air blower is so configured as to send air inside the power conversion unit into the housing outside the power conversion unit and send air containing heat radiated from the power conversion unit into the housing where the storage portion is arranged.

A power generation system according to a second aspect of the present invention includes a power generation module that generates power with natural energy, interconnected to a power grid, a power converter that converts power from the power grid to direct current, a storage portion that stores at least the power converted to direct current by the power converter, a housing that houses at least the storage portion and the power converter, an air blower provided in the housing, and a box-shaped power conversion unit that houses the power converter, arranged inside the housing, while the air blower is so configured as to send air inside the power conversion unit into the housing outside the power conversion unit and send air containing heat radiated from the power conversion unit into the housing where the storage portion is arranged.

According to the present invention, decrease in the temperature of the storage portion in the housing can be effectively suppressed. Thus, the storage portion can be sufficiently charged even if the storage portion is placed in an environment where the air temperature may decrease significantly. Furthermore, no dedicated heater for heating the storage portion may be provided separately in the housing, and hence the storage portion can be heated while increase in the size of the housing and complication of the structure of the storage unit both resulting from a separately provided heater are suppressed.

### BRIEF DESCRIPTION OF THE DRAWINGS

FIG. 1 is a block diagram showing the structure of a power generation system according to a first embodiment of the present invention;

FIG. 2 is a diagram for illustrating the detailed structures (a first state and a fourth state) of changeover switches of the power generation system according to the first embodiment shown in FIG. 1;

FIG. 3 is a diagram for illustrating the detailed structures (a second state and a third state) of the changeover switches of the power generation system according to the first embodiment shown in FIG. 1;

FIG. 4 is a diagram for illustrating the detailed structures (the second state and the fourth state) of the changeover switches of the power generation system according to the first embodiment shown in FIG. 1;

FIG. 5 is a perspective view showing a storage unit of the power generation system according to the first embodiment of the present invention;

FIG. 6 is a top plan view showing the storage unit of the power generation system according to the first embodiment of the present invention;

FIG. 7 is a sectional view showing the storage unit of the power generation system according to the first embodiment of the present invention;

FIG. 8 is a block diagram showing the structure of a power generation system according to a second embodiment of the present invention;

FIG. 9 is a top plan view showing a storage unit of a power generation system according to a third embodiment of the present invention;

FIG. 10 is a sectional view showing the storage unit of the power generation system according to the third embodiment of the present invention; and

FIG. 11 is a top plan view showing a storage unit of a power generation system according to a modification of the first embodiment of the present invention.

### DESCRIPTION OF THE PREFERRED EMBODIMENTS

Embodiments of the present invention are now described with reference to the drawings.

### First Embodiment

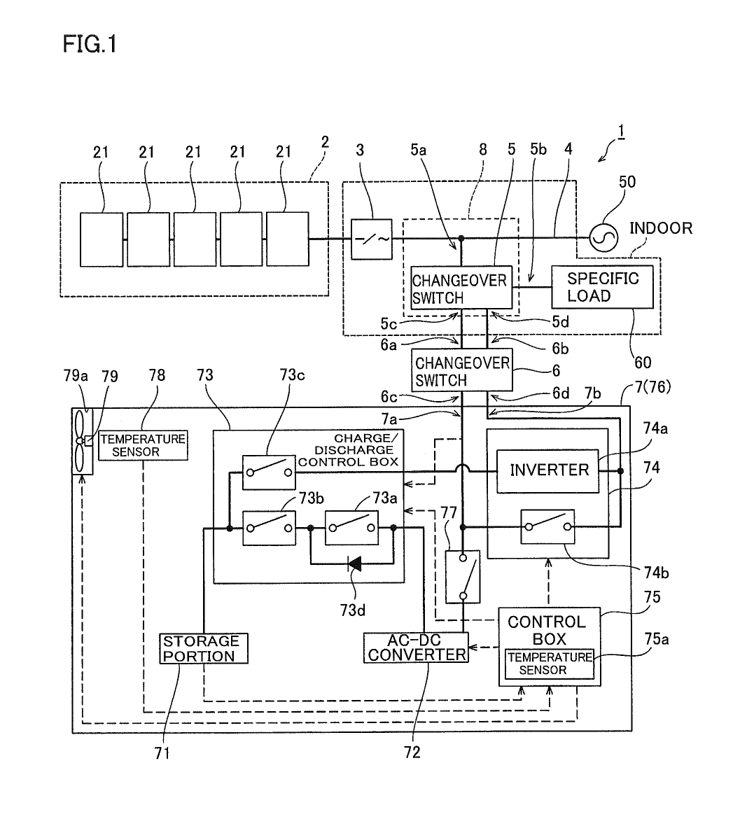

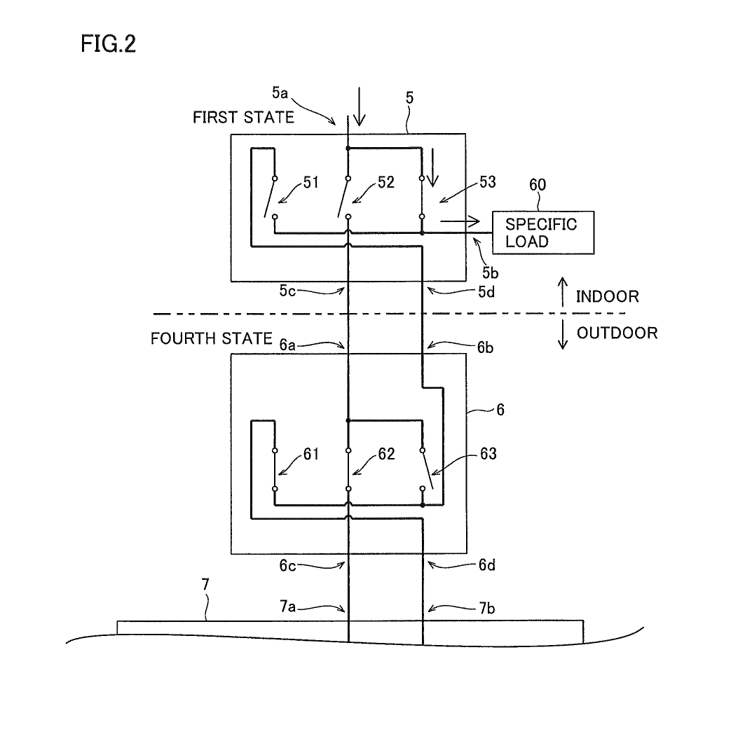

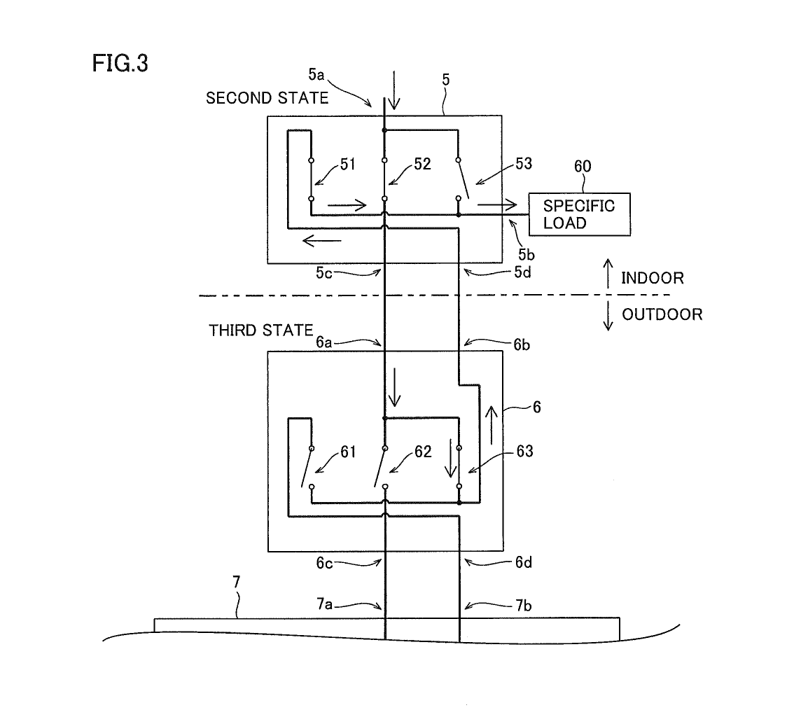

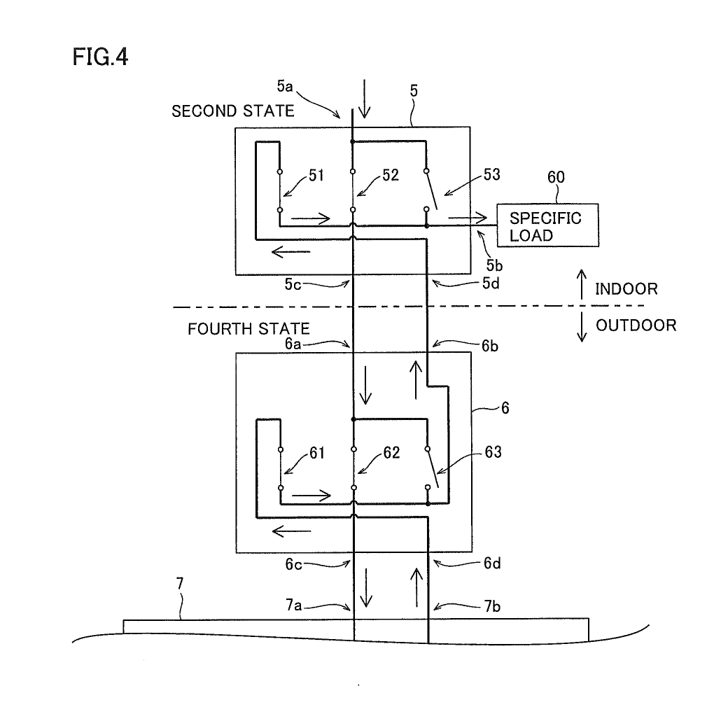

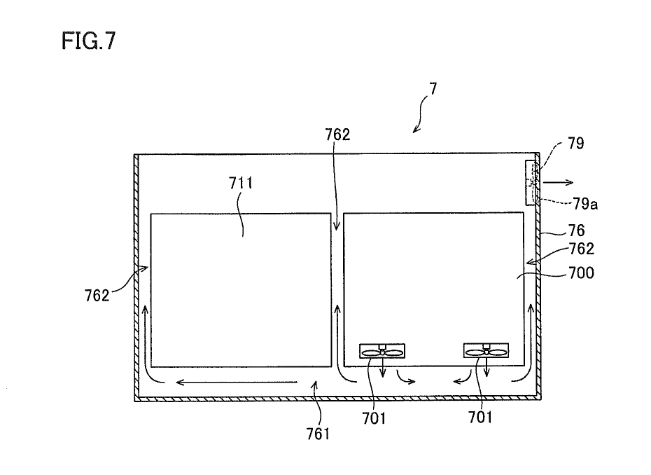

First, the structure of a power generation system (photovoltaic power generation system 1) according to a first embodiment of the present invention is described with reference to FIGS. 1 to 7.

The photovoltaic power generation system 1 includes a generated power output portion 2 outputting power generated with sunlight, an inverter 3 connected to a power grid 50 for outputting the power output from the generated power output portion 2 to the power grid 50 so that a reverse power flow is possible, changeover switches 5 and 6 for backup connected to a bus 4 connecting the inverter 3 and the power grid 50, and a storage unit 7 connected to the changeover switch 6.

The inverter 3 has a function of converting direct-current power output from the generated power output portion 2 to alternating current. The generated power output portion 2 is interconnected to the power grid 50 through the inverter 3.

The changeover switch 5 is connected with a specific load 60. The specific load 60 is an apparatus driven by an alternating-current power source. The specific load 60 includes an apparatus desired to be regularly supplied with power from a power source and having a possibility of regularly operating.

The generated power output portion 2 includes a plurality of photovoltaic power generation modules 21 connected in series to each other. The photovoltaic power generation modules 21 can be constituted by various types of solar cells such as thin film silicon-based solar cells, crystalline silicon-based solar cells, or compound semiconductor-based solar cells. The photovoltaic power generation modules 21 are examples of the “power generation module” in the present invention.

The changeover switch 5 is connected to the bus 4 through a wire 5a, and connected to the specific load 60 through a wire 5b. The changeover switch 5 is connected to the changeover switch 6 through wires 5c and 5d and wires 6a and 6b. The changeover switch 5 is provided to be capable of switching a first state where only the wires 5a and 5b are electrically connected to each other and a second state where the wires 5a and 5c are electrically connected to each other while the wires 5b and 5d are connected to each other.

In the first state, the wire 5a and the wire 5b are connected to each other through a changeover switch 53 that is turned on, the wire 5a and the wire 5c are disconnected from each other by a changeover switch 52 that is turned off, and the wire 5d and the wire 5b are disconnected from each other by a changeover switch 51 that is turned off. In this first state, the changeover switch 5 and the changeover switch 6 are electrically disconnected from each other, whereby the bus 4 and the storage unit 7 are electrically separated from each other.

In the second state, the wire 5a and the wire 5b are disconnected from each other by the changeover switch 53 that is turned off, the wire 5a and the wire 5c are connected to each other through the changeover switch 52 that is turned on, and the wire 5d and the wire 5b are connected to each other through the changeover switch 51 that is turned on. In this second state, the changeover switch 5 and the changeover switch 6 are electrically connected to each other.

The changeover switch 5 is provided in a distribution board 8 placed indoors. The specific load 60 and the inverter 3 are also placed indoors.

The changeover switch 6 is electrically connected with an AC-DC converter 72 through a wire 6c and a wire 7a of the storage unit 7. The changeover switch 6 is connected to an inverter 74a in the storage unit 7 through a wire 6d and a wire 7b of the storage unit 7. The changeover switch 6 is provided to be capable of switching a third state where only the wires 6a and 6b are connected to each other and a fourth state where the wires 6a and 6c are connected to each other while the wires 6b and 6d are connected to each other. The inverter 74a is an example of the “power converter” or the “second power converter” in the present invention.

In the third state, the wire 6a and the wire 6b are connected to each other through a changeover switch 63 that is turned on, the wire 6a and the wire 6c are disconnected from each other by a changeover switch 62 that is turned off, and the wire 6d and the wire 6b are disconnected from each other by a changeover switch 61 that is turned off. The changeover switch 6 and the storage unit 7 are electrically disconnected from each other, whereby the bus 4 and the storage unit 7 are electrically separated from each other. In the fourth state, the wire 6a and the wire 6b are disconnected from each other by the changeover switch 63 that is turned off, the wire 6a and the wire 6c are connected to each other through the changeover switch 62 that is turned on, and the wire 6d and the wire 6b are connected to each other through the changeover switch 61 that is turned on. In this fourth state, the changeover switch 6 and the storage unit 7 are electrically connected to each other, whereby the bus 4 and the storage unit 7 are electrically connected to each other through the changeover switch 5 in the second state.

The changeover switch 5 and the changeover switch 6 can switch a current path independently from each other. In the first embodiment, the indoor changeover switch 5 or the outdoor changeover switch 6 is operated, whereby the bus 4 and the storage unit 7 can be electrically separated from each other. Thus, when the storage unit 7 is repaired, for example, the changeover switch 5 is switched to the first state indoors, or the changeover switch 6 is switched to the third state outdoors, whereby the storage unit 7 can be detached in a state where electricity is not conducted from the bus 4 to the storage unit 7. In the state where the storage unit 7 is detached, the changeover switch 5 is switched to the first state, whereby power is directly supplied from the power grid 50 or the generated power output portion 2 to the specific load 60 through a current path passing through the wires 5a and 5b. Also, when the changeover switches 5 and 6 are switched to the second state and the third state, respectively, in the state where the storage unit 7 is detached, power is directly supplied from the power grid 50 or the generated power output portion 2 to the specific load 60 through a current path passing through the wires 5a, 5c, 6a, 6b, 5d, and 5b, similarly.

When the changeover switch 5 is switched to the second state while the changeover switch 6 is switched to the fourth state, the bus 4 and the storage unit 7 are electrically connected to each other through the changeover switch 5 and the changeover switch 6. In this state, the bus 4 and a storage portion 71 of the storage unit 7 are connected to each other while the storage portion 71 and the specific load 60 are connected to each other, as described later. Thus, power from the power grid 50 or the generated power output portion 2 can be stored in the storage portion 71, and the power in the storage portion 71 can be supplied to the specific load 60. Switches inside the storage unit 7 are switched to switch a current path in the storage unit 7, whereby the power from the power grid 50 or the generated power output portion 2 can be supplied to the specific load 60 not the storage portion 71.

Next, the structure of the storage unit 7 is described.

The storage unit 7 mainly includes the storage portion 71 storing the power from the power grid 50, the AC-DC converter 72 converting power from alternating current to direct current, a charge/discharge control box 73 to control charge/discharge of the storage portion 71, an inverter unit 74 to supply power from the storage portion 71 or the bus 4 to the specific load 60, and a control box 75 controlling devices such as the storage portion 71, the AC-DC converter 72, and the charge/discharge control box 73. These devices are collectively housed in a housing 76, and can be treated as a single unit. The AC-DC converter 72 is an example of the “power converter” or the “first power converter” in the present invention. The control box 75 is an example of the “control portion” in the present invention.

This storage unit 7 is placed outdoors, and has the wire 7a to receive power from the power grid 50 and the wire 7b to supply power to the specific load 60. The wires 7a and 7b are connected to the wires 6c and 6d of the changeover switch 6 provided outdoors, respectively, whereby the power from the power grid 50 can be stored in the storage portion 71, and the stored power can be supplied to the specific load 60.

As the storage portion 71, a secondary battery (lithium ion storage battery, for example) exhibiting a small amount of natural discharge and having high charging/discharging efficiency is employed. The lithium ion storage battery has a property of absorbing heat during charge.

The charge/discharge control box 73 includes three switches 73a, 73b, and 73c capable of being switched on/off by the control box 75. The switches 73a and 73b are connected in series to each other in a charging path between the AC-DC converter 72 and the storage portion 71. A diode 73d rectifying current from the AC-DC converter 72 toward the storage portion 71 is provided on a bypass path provided in parallel with the switch 73a. The switch 73c is provided in a discharging path between the storage portion 71 and the inverter unit 74.

When the storage portion 71 is charged from the power grid 50, the switch 73b is first turned on, and then the switch 73a is turned on. Thus, the diode 73d can prevent a reverse flow from the storage portion 71 to the AC-DC converter 72, resulting from the low output voltage of the AC-DC converter 72 immediately after start of the AC-DC converter 72.

When power is discharged from the storage portion 71 to the specific load 60 through the inverter unit 74, the switch 73c is turned on. The switch 73a is turned off, and then the switch 73b is turned off. Similarly in this case, the diode 73d can prevent a reverse flow from the storage portion 71 to the AC-DC converter 72. When all the switches 73a, 73b, and 73c are turned on, both the charge and discharge of the storage portion 71 can be performed.

The inverter unit 74 includes the inverter 74a serving as a DC-AC converter to supply power in the storage portion 71 outputting direct-current power to the specific load 60 driven by the alternating-current power source and a switch 74b capable of being switched on/off. The switch 74b is provided between the wire 7a and the wire 7b. The switch 74b is usually turned on, and the inverter 74a turns off the switch 74b when power is supplied to the inverter 74a, and preferably when power of at least a prescribed voltage is supplied to the inverter 74a.

A switch 77 capable of being switched on/off is provided in a portion of a current path between the wire 7a and the AC-DC converter 72 closer to the AC-DC converter 72 beyond a contact point with the switch 74b. This switch 77 is so configured as to be switched on/off in response to the temperature of a temperature sensor 75a provided in the control box 75. In other words, when the temperature of the temperature sensor 75a is not more than a prescribed temperature (about 70° C., for example), the switch 77 is turned on so that power from the bus 4 is supplied to the AC-DC converter 72. When the temperature of the temperature sensor 75a is more than the prescribed temperature, the switch 77 is turned off so that the bus 4 and the AC-DC converter 72 are electrically disconnected from each other. The control box 75 controls ON/OFF of the switch 77. The temperature sensor 75a is an example of the “second temperature detection portion” in the present invention.

The control box 75 is powered from a wire between the switch 77 and the AC-DC converter 72, so that driving of the control box 75 automatically stops because of no power source when the switch 77 is turned off. When the control box 75 stops, output from the AC-DC converter 72 is turned off (power supply to the AC-DC converter 72 is also disrupted), and the switches 73a and 73c are turned off. The switch 73c is turned off, whereby power supply to the inverter 74a is disrupted. The power supply to the inverter 74a is disrupted, whereby the switch 74b is turned on, as described above. The switch 74b is turned on, whereby the power from the bus 4 can be supplied to the specific load 60 not through the storage portion 71 but through a current path passing through the wire 7a, the switch 74b, and the wire 7b when the changeover switch 5 and the changeover switch 6 are in the second state and the fourth state, respectively.

Therefore, when the temperature in the housing 76 is low, the switch 74b and the switch 77 are turned off and on, respectively. When the inside of the housing 76 is in an abnormally heated state (the temperature in the control box 75 is at least about 70° C., for example), the switch 74b and the switch 77 are turned on and off, respectively. Thus, when the inside of the housing 76 is in the abnormally heated state, the AC-DC converter 72 and the inverter 74a that are heat generating sources, the storage portion 71, and the control box 75 can be stopped while the power supply from the bus 4 to the specific load 60 is maintained. Consequently, when the inside of the housing 76 is in the abnormally heated state, further increase in the temperature can be suppressed so that thermal damage to each device in the housing 76 can be reduced.

In the housing 76, a temperature sensor 78 and an exhaust fan 79 attached to a vent 79a are further provided. When the detection temperature of the temperature sensor 78 is at least a prescribed temperature (about 40° C.), the exhaust fan 79 is driven so that heat can be exhausted out of the housing 76. The temperature sensor 78 and the exhaust fan 79 are not connected to other devices (the storage portion 71, the control box 75, etc.) in the housing 76, but powered from the wire 7a to be driven. Consequently, the temperature sensor 78 and the exhaust fan 79 operate electrically independently from other devices (the storage portion 71, the control box 75, etc.) in the housing 76 even when the switch 77 is turned off. The temperature sensor 78 is an example of the “first temperature detection portion” in the present invention. The exhaust fan 79 is an example of the “fan” in the present invention.

If determining that the temperature in the housing 76 is at least the prescribed temperature (the temperature in the control box 75 is about 70° C., for example) on the basis of the detection result of the temperature sensor 75a, the control box 75 determines that the inside of the housing 76 is in the abnormally heated state, and turns off the switch 77. In a normal state (state that is not the abnormally heated state), the control box 75 controls ON/OFF of the switches of the charge/discharge control box 73, the output of the AC-DC converter 72, the switch 74b of the inverter unit 74, etc. on the basis of a prescribed program or the like.

The control box 75 controls each switch to charge the storage portion 71 from the power grid 50 in the middle of the night, for example, in the normal operation and supply power from the storage portion 71 to the specific load 60 at any time of the day or night when power supply to the specific load 60 is required. A current path to charge the storage portion 71 by supplying power from the bus 4 to the storage portion 71 is a path passing through the wire 7a, the switch 77, the AC-DC converter 72, the switch 73a, and the switch 73b. A current path to supply power to the specific load 60 by discharging the storage portion 71 is a path passing through the switch 73c, the inverter 74a, and the wire 7b. The power stored in the storage portion 71 is not supplied to the power grid 50. The control box 75 controls the discharge of the storage portion 71 so that the residual capacity of the storage portion 71 does not fall to a prescribed threshold (50% of a fully-charged state, for example) or less even when the storage portion 71 is discharged in the normal operation. If determining that the residual capacity of the storage portion 71 has fallen to the threshold or less, the control box 75 stops power supply from the storage portion 71 to the specific load 60, and switches each switch to supply power directly from the bus 4 to the specific load 60. Specifically, the control box 75 turns off the switch 73c of the charge/discharge control box 73 and turns on the switch 74b of the inverter unit 74. In this case, the output of the AC-DC converter 72 is turned off, and no power charge is performed in the daytime hours. However, if the voltage of power reversely flowing from a consumer exceeds the allowable voltage of a distribution line, or the amount of power demand is expected to fall much below the amount of power generation, the control box 75 controls the AC-DC converter 72 and each switch to charge the storage portion 71.

In a time of emergency such as a power outage, power supply from the power grid 50 is stopped, so that the control box 75 is stopped. Furthermore, the switch 77 and the switches 73a and 73b are turned off. Thus, power is not supplied to the AC-DC converter 72, so that driving of the AC-DC converter 72 is also stopped. A voltage line signal of the wire 7a is input to the switch 73c, and detects that no voltage is applied to the wire 7a in the case of a power outage, whereby the switch 73c is turned on. The inverter 74a is so configured as to be activated by power supply from the storage portion 71.

In the first embodiment, the control box 75 controls the discharge of the storage portion 71 so that the residual capacity of the storage portion 71 does not fall to the prescribed threshold (50%, for example) or less in the normal operation. Consequently, a larger amount of power than the threshold (50% of the fully charged state) is certainly stored in the storage portion 71 when the discharge of the storage portion 71 to the specific load 60 starts in the time of emergency such as a power outage. In the case of a power outage, the control box 75 controls the charge/discharge control box 73 to discharge the storage portion 71 even if the amount of power stored in the storage portion 71 falls to the prescribed threshold (50% of the fully-charged state) or less, dissimilarly in the normal operation. In the time of emergency, power supply to the control box 75 is stopped, and the switch 73c cannot be switched on/off. However, the stored power can be effectively utilized by employing a lithium ion storage battery, for example, as in the first embodiment.

Next, the specific structure of the storage unit 7 is described.

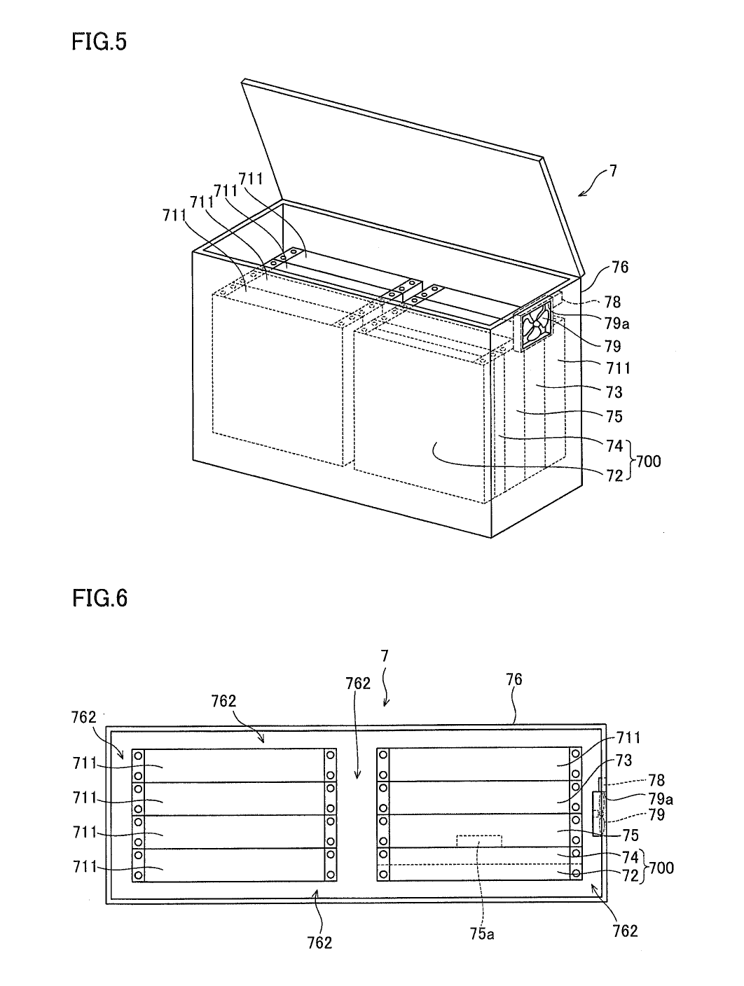

As shown in FIGS. 5 to 7, the storage unit 7 includes five lithium ion storage batteries 711 each in the form of a box, the charge/discharge control box 73 in the form of a box, the control box 75 in the form of a box, and a power conversion unit 700 in the form of a box constituted by the inverter unit 74 and the AC-DC converter 72 that are integrally formed, all housed in the housing 76 in the form of a box. The lithium ion storage batteries 711 each are a storage battery unit in the form of a pack having a large number of lithium ion storage battery cells inside. The five lithium ion storage batteries 711 constitute the storage portion 71. These eight devices (the five lithium ion storage batteries 711, the charge/discharge control box 73, the control box 75, and the power conversion unit 700) are adjacently arranged in a transverse direction. As shown in FIGS. 5 and 6, the control box 75 and the power conversion unit 700 are adjacent to each other. In the power conversion unit 700, the inverter unit 74 is arranged on the side closer to the control box 75. In other words, the AC-DC converter 72 is arranged in a position separated from the control box 75 through the inverter unit 74. The temperature sensor 75a of the control box 75 is arranged on the side closer to the inverter unit 74. The exhaust fan 79 is provided on an upper side surface of the housing 76, and attached to the vent 79a in communication with the outside of the housing 76. The temperature sensor 78 is arranged adjacent to the exhaust fan 79.

Two heat radiation fans 701 are integrally provided on the lower portion of the power conversion unit 700 to exhaust heat generated by driving of the AC-DC converter 72 and the inverter 74a from the power conversion unit 700 into the housing 76. The heat radiation fans 701 are examples of the “air blower” in the present invention. These heat radiation fans 701 are so arranged as to send air containing heat in the power conversion unit 700 downward from the lower surface of the power conversion unit 700 to the lower side (inner bottom surface) of the housing 76.

An air circulation path 761 is provided between the inner bottom surface of the housing 76 and each device (the lithium ion storage batteries 711, the charge/discharge control box 73, the control box 75, the power conversion unit 700, etc.). Thus, air sent by the heat radiation fans 701 is circulated on the lower surface side of each device including the lithium ion storage batteries 711 (in the air circulation path 761) to be spread throughout the inner bottom surface of the housing 76. Furthermore, an air circulation path 762 vertically extending, in communication with the air circulation path 761 is provided between the inner side surfaces of the housing 76 and each device and between each device (in the central portion in the housing 76). The air circulation path 762 has a function of circulating the air sent by the heat radiation fans 701 along the side surfaces of each device including the lithium ion storage batteries 711 from a lower portion to an upper portion in the housing 76. Thus, the air containing heat exhausted from the power conversion unit 700 is circulated along the lower surfaces of the lithium ion storage batteries 711 through the air circulation path 761 in the inner lower portion of the housing 76. Thereafter, the air exhausted from the power conversion unit 700 rises along the side surfaces of the lithium ion storage batteries 711 through the air circulation path 762, and is spread to the upper portion of the housing 76. Consequently, the heat exhausted from the power conversion unit 700 is efficiently transmitted to the lithium ion storage batteries 711. The air circulation paths 761 and 762 are examples of the “first circulation path” and the “second circulation path” in the present invention, respectively.

In the storage unit 7, the lithium ion storage batteries 711 are heated by utilizing the heat exhausted from the power conversion unit 700 into the housing 76. Particularly, the AC-DC converter 72 constituting the power conversion unit 700 easily generates heat, and hence the lithium ion storage batteries 711 can be easily heated by utilizing this heat. The lithium ion storage batteries 711 each are small-sized as compared with a lead storage battery or the like, and hence from this aspect, the lithium ion storage batteries 711 can be sufficiently heated by utilizing the heat from the power conversion unit 700. Furthermore, the lithium ion storage batteries 711 are arranged in the vicinity of the power conversion unit 700 that is a heat generating source, and hence also from this aspect, the lithium ion storage batteries 711 can be easily heated. Heat accumulated in the housing 76 is exhausted from the upper portion of the housing 76 through the exhaust fan 79 when the temperature in the housing 76 is higher than the prescribed temperature (about 40° C.). Each of the lithium ion storage batteries 711, the charge/discharge control box 73, and the power conversion unit 700 are provided with communication portions (not shown) to communicate states (temperature states, for example) of these devices to the control box 75. The communication portions of the lithium ion storage batteries 711 are daisy-chained in series to each other, and are so configured that the five lithium ion storage batteries 711 are treated as a unit.

The housing 76 is provided to house the storage portion 71 and the AC-DC converter 72, and the storage portion 71 is heated by utilizing the heat radiated from the AC-DC converter 72 into the housing 76, whereby decrease in the temperature (temperature of the storage portion 71) in the housing 76 can be effectively suppressed even when the air temperature outside the housing 76 is low. Thus, even if the storage portion 71 is placed in an environment (the middle of the night in winter, a cold region, etc., for example) where the air temperature may decrease significantly, the storage portion 71 can be sufficiently charged. Furthermore, the storage portion 71 is heated by utilizing the heat radiated from the AC-DC converter 72 into the housing 76, whereby the storage portion 71 can be heated by employing the AC-DC converter 72 necessary to charge the storage portion 71 with the power from the power grid 50, so that no dedicated heater for heating the storage portion 71 may be provided separately in the housing 76. Thus, the storage portion 71 can be heated while increase in the size of the housing 76 and complication of the structure of the storage unit 7 both resulting from a separately provided heater are suppressed.

Particularly when the lithium ion storage batteries 711 each having a property of decreasing atmosphere temperature by absorbing heat during charge are employed, decrease in the temperature (temperature of the lithium ion storage batteries 711) in the housing 76 can be effectively suppressed by heating by the heat radiated from the AC-DC converter 72.

According to the first embodiment, as hereinabove described, the heat radiation fans 701 are provided to send the air containing the heat radiated from the AC-DC converter 72 to the inner lower side of the housing 76, whereby the heat temporarily sent to the inner lower side of the housing 76 rises to the inner upper side of the housing 76, so that the inside (five lithium ion storage batteries 711) of the housing 76 can be uniformly heated.

The air containing the heat generated in the AC-DC converter 72 is sent to the inner lower side of the housing 76 by the heat radiation fans 701 integrally provided on the AC-DC converter 72, whereby the inside (storage portion 71) of the housing 76 can be uniformly heated employing the heat radiation fans 701 provided on the AC-DC converter 72.

The air containing the heat exhausted from the power conversion unit 700 is circulated along the lower surfaces of the lithium ion storage batteries 711 through the air circulation path 761 in the inner lower portion of the housing 76, and circulated along the side surfaces of the lithium ion storage batteries 711 through the air circulation path 762. According to this structure, the heat exhausted from the power conversion unit 700 can be efficiently transmitted from the lower surface side and the side surface side of the lithium ion storage batteries 711.

The heat radiation fans 711 are provided in the box-shaped power conversion unit 700 constituted by the inverter unit 74 and the AC-DC converter 72, and are so configured as to send the air containing the heat of the power conversion unit 700 to the air circulation path 761 on the lower side, whereby the air containing the heat radiated from the inverter unit 74 and the AC-DC converter 72 can be reliably sent to the air circulation path 761. Consequently, the heat radiated from the inverter unit 74 and the AC-DC converter 72 can be efficiently transmitted to the lithium ion storage batteries 711.

The common heat radiation fans 711 are integrally provided on the lower portion of the power conversion unit 700 to exhaust the heat radiated from the AC-DC converter 72 and the inverter 74a from the power conversion unit 700 into the housing 76. According to this structure, the storage portion 71 can be heated by utilizing both the heat radiated from the AC-DC converter 72 during the charge of the storage portion 71 and the heat radiated from the inverter 74a during the power supply from the storage portion 71 to the specific load 60. Furthermore, increase in the number of components can be suppressed by employing the common heat radiation fans 701.

The exhaust fan 79 is so configured as to exhaust heat out of the housing 76 when the detection temperature of the temperature sensor 78 reaches at least the prescribed temperature (about 40° C.). According to this structure, the storage portion 71 can be inhibited from being heated beyond necessity, and hence the storage portion 71 can be charged/discharged in a proper temperature range in which the charging performance of the storage portion 71 is not degraded.

If determining that the temperature in the housing 76 has reached at least the prescribed temperature on the basis of the detection result of the temperature sensor 75a, the control box 75 stops the charge/discharge of the storage portion 71. According to this structure, heat generation (charge/discharge) in the storage unit 7 can be stopped on the basis of the detection result of the temperature sensor 75a even if the temperature in the housing 76 increases, and hence excessive increase in the temperature of the storage portion 71 can be suppressed.

The inverter 74a converting power from direct current to alternating current or direct current, housed in the housing 76 is not connected to the power grid 50 but arranged on the path to supply power from the storage portion 71 to the specific load 60, whereby decrease in the temperature in the housing 76 can be more effectively suppressed by employing the heat radiated from the inverter 74a driven when power is supplied from the storage portion 71 to the specific load 60. In a case of the inverter 74a converting power from direct current to alternating current, the inverter 74a is not connected to the power grid 50 but arranged on the path to supply power from the storage portion 71 to the specific load 60, whereby no power converter (power converter like the inverter 3) for grid interconnection with a complicated structure, having a large number of restrictions imposed through standards may be employed as the inverter 74a, but a power converter having a simple structure can be employed.

Next, a specific example of the aforementioned photovoltaic power generation system 1 according to the first embodiment is described.

The capacity of the storage portion 71 is set at 7.85 kWh while the output power of the AC-DC converter 72 is set at 1.5 kW, and the photovoltaic power generation system 1 is so designed as to spend at least a half of midnight power hours (8 hours from 23:00 to 7:00, for example) charging the storage portion 71 from a zero state to the fully-charged state. In this case, a simple calculation shows that charging time is at least 5 hours. In a lithium ion storage battery, the charging rate must be slowed as full charge approaches, and hence actual charging time is further increased.

If the power consumption of the specific load 60 is set at about 600 Wh, an amount of power of about 3 kWh is required to drive the specific load 60 for 5 hours. If power is supplied from the storage portion 71 to the specific load 60 in the case of a five-hour power outage, the storage portion 71 must have a capacity of at least about 3 kWh. The discharge of the storage portion 71 is controlled to stop when the residual capacity of the storage portion 71 falls to 50% of the capacity of the storage portion 71, so that a capacity of at least about 6 kWh is required to continuously drive the specific load 60 with a capacity of 50% of the fully-charged state in the case of a five-hour power outage. To be safe, a value of 7.85 kWh larger than 6 kWh is determined.

The photovoltaic power generation system 1 is designed on the assumption that the power stored in the storage portion 71 is not fully discharged in a short time but output over a long time. Preferably, the amount of power used by the specific load 60 per day is smaller than the storage capacity, and is so set that the specific load 60 can be driven for at least five hours, for example, with the power stored in the storage portion 71. If the specific load 60 is not employed, it is difficult to set the amount of load, and it is also difficult to properly set the capacity of the storage portion 71. In this example, the power rating of the inverter 74a is set at 1 kW, and the power consumption of the specific load 60 is set at about 1 kW at a maximum.

On the assumption of the aforementioned structure of the example, a difference between a case of employing a lithium ion storage battery as the storage portion 71 and a case of employing a lead storage battery as the storage portion 71 is now described.

The volume energy density of the lead storage battery is about 50 Wh/L to 100 Wh/L, and the volume energy density of the lithium ion storage battery is about 400 Wh/L to 600 Wh/L. Therefore, if the volume energy densities of the lead storage battery and the lithium ion storage battery are set at 100 Wh/L and 500 Wh/L, respectively, a difference between the volume energy densities is five times. In other words, if the storage portion is housed in the housing 76, the volume of the housing 76 in a case of the lead storage battery must be about five times the volume of the housing 76 in a case of the lithium ion storage battery. In this case, a difference between the surface areas of the housing 76 is about twice. The surface area of the housing 76 is conceivably proportionate to the radiation amount of the housing 76, and hence a difference in the amount of heat required to increase the temperature in the housing 76 to a given temperature between the lead storage battery and the lithium ion storage battery is about ten times on the basis of the volume ratio (about five times) of the housing 76 and the surface area ratio (about twice) of the housing 76.

The amount of heat generation of the AC-DC converter 72 that is a heat generating source in the first embodiment is proportionate to the output value of the AC-DC converter 72, and the output value of the AC-DC converter 72 is determined depending on the capacity of the storage portion 71, as assumed above, whereby if the capacities of the lead storage battery and the lithium ion storage battery are the same, the amount of heat generation of the AC-DC converter 72 in the case of the lead storage battery and the amount of heat generation of the AC-DC converter 72 in the case of the lithium ion storage battery are also the same. Therefore, the effect of increasing the temperature in the housing 76 due to heat generation of the AC-DC converter 72 in the case of the lead storage battery is about one-tenth of that in the case of the lithium ion storage battery.

The lead storage battery radiates heat during charge (increases the temperature in the housing 76), and hence a heat sink for radiating heat is often provided in the housing 76 housing the lead storage battery to suppress increase in the temperature during charge. In this case, the effect of increasing the temperature of about one-tenth of that in the case of employing the lithium ion storage battery is further suppressed by the heat sink, and hence a difference between the effect of increasing the temperature in the case of the lead storage battery and the effect of increasing the temperature in this example battery is further increased.

The temperature range enabling charge and discharge of the lithium ion storage battery is wider than that of the lead storage battery.

In view of the above, the lithium ion storage battery can be appropriately employed as the storage portion 71 of the photovoltaic power generation system 1 according to the first embodiment.

### Second Embodiment

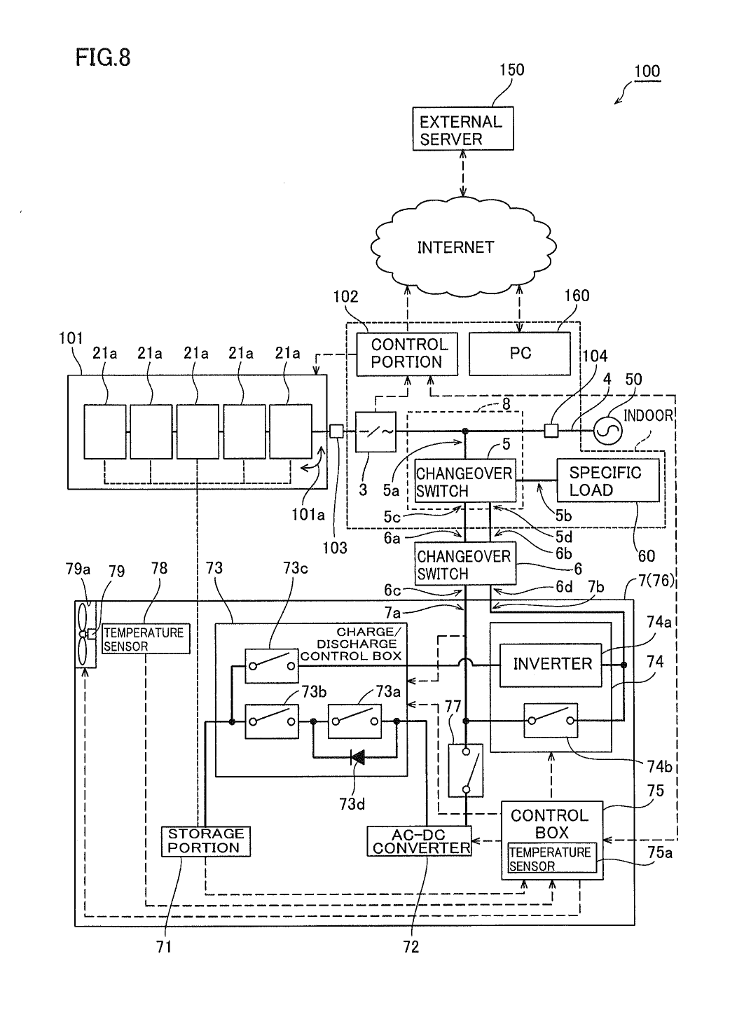

Next, a power generation system (photovoltaic power generation system 100) according to a second embodiment of the present invention is now described with reference to FIG. 8. In this second embodiment, power generated by a plurality of photovoltaic power generation modules 21a can be stored in a storage portion 71, dissimilarly to the aforementioned first embodiment.

In the second embodiment, a generated power output portion 101 includes the plurality of photovoltaic power generation modules 21a connected to each other and a switching circuit portion 101a selectively switchably connecting the power generated by the photovoltaic power generation modules 21a to the side of an inverter 3 or to the side of the storage portion 71 of a storage unit 7.

The switching circuit portion 101a is so configured as to electrically disconnect the generated power output portion 101 and the storage portion 71 from each other in a case of connecting the generated power output portion 101 to the side of the inverter 3, and as to electrically disconnect the generated power output portion 101 and the inverter 3 from each other in a case of connecting the generated power output portion 101 to the side of the storage portion 71. Furthermore, the switching circuit portion 101a is capable of switching a connection state between the five photovoltaic power generation modules 21a to a series connection state where the five photovoltaic power generation modules 21a are connected in series to each other in the case of connecting the generated power output portion 101 to the side of the inverter 3. In addition, the switching circuit portion 101a is capable of switching the connection state between the five photovoltaic power generation modules 21a to a parallel connection state where the five photovoltaic power generation modules 21a are connected in parallel to each other in the case of connecting the generated power output portion 101 to the side of the storage portion 71.

A control portion 102 capable of communicating with a control box 75 of the storage unit 7 is provided. The control portion 102 has a function of transmitting a control command to the control box 75 of the storage unit 7 and receiving information related to the storage unit 7 such as the amount of power stored in the storage portion 71 from the control box 75 on the basis of the amount of power generation of the generated power output portion 101, the charging amount of the storage portion 71, the operating situation of the inverter 3, preset set information, etc. The control portion 102 also has a function of controlling the switching circuit portion 101a of the generated power output portion 101 etc. on the basis of the amount of power generation of the generated power output portion 101, the charging amount of the storage portion 71, the operating situation of the inverter 3, the preset set information, etc. More specifically, the control portion 102 determines whether the system is in normal operation or in an emergency state on the basis of the charging amount of the storage portion 71, the operating situation of the inverter 3, the preset set information, etc.

If determining that the system is in the normal operation, the control portion 102 controls the switching circuit portion 101a to bring the photovoltaic power generation modules 21a into the series connection state and switch the connection target of the generated power output portion 101 to the side of the inverter 3. In the normal operation, power output from the generated power output portion 101 is consumed in a specific load 60 or the like, and surplus power is made to reversely flow into a power grid 50.

If determining that the system is in the emergency state, the control portion 102 controls the switching circuit portion 101a to bring the photovoltaic power generation modules 21a into the parallel connection state and switch the connection target of the generated power output portion 101 to the side of the storage portion 71. In the emergency state, the power output from the generated power output portion 101 is supplied to the storage portion 71, and the specific load 60 is driven by the charging power of the storage portion 71 and the power output from the generated power output portion 101.

The control portion 102 can detect the amount of power generation of the photovoltaic power generation modules 21a, the amount of reverse flow power (amount of power to be sold), the amount of power consumed by the specific load 60, etc. on the basis of the detection results of a current detection portion 103 provided on the side of the inverter 3 closer to the generated power output portion 101 and a current detection portion 104 provided on the side of the inverter 3 closer to the power grid 50. Furthermore, the control portion 102 is so configured as to transmit the amount of power generation of the photovoltaic power generation modules 21a, the amount of reverse flow power (amount of power to be sold), the amount of power consumed by the specific load 60, the state (the charging amount, the temperature state, etc.) of the storage portion 71, and another kind of information related to the photovoltaic power generation system 100 to an external server 150 through the Internet. This external server 150 is a server of a maintenance company of the photovoltaic power generation system 100, for example. Thus, the maintenance company can grasp the state of the photovoltaic power generation system 100 any time. This external server 150 can be accessed from a PC (personal computer) 160 or the like of a user through the Internet, and the user can confirm the state of his/her own photovoltaic power generation system 100 with the PC 160.

The remaining structure of the photovoltaic power generation system 100 according to the second embodiment is similar to that of the photovoltaic power generation system 1 according to the aforementioned first embodiment.

According to the second embodiment, in a time of emergency, the power generated by the photovoltaic power generation modules 21a can be stored in the storage portion 71, and hence the specific load 60 can be driven for a longer time.

The remaining effects of the second embodiment are similar to those of the aforementioned first embodiment.

### Third Embodiment

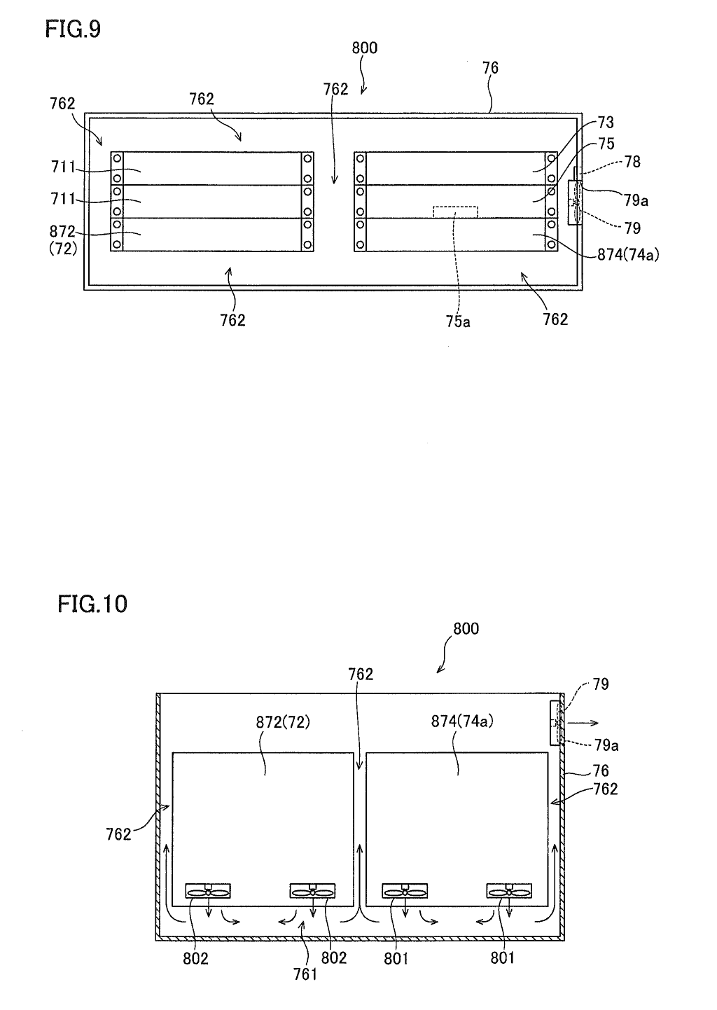

A storage unit 800 of a power generation system according to a third embodiment of the present invention is now described with reference to FIGS. 9 and 10. In this third embodiment, an inverter unit 874 and an AC-DC converter unit 872 are provided as separate units, dissimilarly to the aforementioned first embodiment. As the structure of a power generation system other than the power generation system including the storage unit 800, any one of the aforementioned first and second embodiments may be applied, and hence description is omitted. The AC-DC converter unit 872 is an example of the “power conversion unit” in the present invention. The inverter unit 874 is an example of the “power conversion unit” in the present invention.

The storage unit 800 according to the third embodiment includes the box-shaped inverter unit 874 and the box-shaped AC-DC converter unit 872 as separate units. An inverter 74a and an AC-DC converter 72 are housed in the inverter unit 874 and the AC-DC converter unit 872, respectively. The storage unit 800 further includes two lithium ion storage batteries 711, a box-shaped charge/discharge control box 73, and a box-shaped control box 75, and is constituted by six box-shaped units in total. In plan view, these units are arranged in three rows and two columns to be adjacent to each other in each column. Specifically, the AC-DC converter unit 872 and the inverter unit 874 are arranged in a row on the front side of the storage unit 800 (on the lower side of FIG. 9), the lithium ion storage battery 711 and the control box 75 are arranged in a middle row, and the lithium ion storage battery 711 and the charge/discharge control box 73 are arranged in a row on the rear side.

Two heat radiation fans 801 are integrally provided on the lower portion of the box-shaped inverter unit 874 to exhaust heat generated by driving of the inverter 74a from the inverter unit 874 into the housing 76. In addition, two heat radiation fans 802 are integrally provided on the lower portion of the box-shaped AC-DC converter unit 872 to exhaust heat generated by driving of the AC-DC converter 72 from the AC-DC converter unit 872 into the housing 76. Thus, in the third embodiment, the inverter unit 874 and the AC-DC converter unit 872 provided separately are provided with the two heat radiation fans 801 and the two heat radiation fans 802, respectively. The heat radiation fans 801 are so arranged as to send air containing heat in the inverter unit 874 downward from the lower surface of the inverter unit 874 to the lower side (inner bottom surface) of the housing 76. The heat radiation fans 802 are so arranged as to send air containing heat in the AC-DC converter unit 872 downward from the lower surface of the AC-DC converter unit 872 to the lower side (inner bottom surface) of the housing 76.

The remaining structure of the storage unit 800 according to the third embodiment is similar to that of the storage unit 7 according to the aforementioned first embodiment.

According to the third embodiment, as hereinabove described, the inverter unit 874 and the AC-DC converter unit 872 are provided as separate units, whereby the surface areas of the inverter unit 874 and the AC-DC converter unit 872 that are heat generating sources, exposed (exposed to air) in the housing 76 can be increased. Thus, the heat generated in the inverter 74a and the AC-DC converter 72 that are heat generating sources can be more efficiently radiated into the housing 76, and hence the effect of increasing the temperature in the housing 76 by heat generation of the inverter 74a and the AC-DC converter 72 can be further improved.

According to the third embodiment, as hereinabove described, the inverter unit 874 and the AC-DC converter unit 872 are provided with the two heat radiation fans 801 and the two heat radiation fans 802, respectively, whereby a larger amount of air containing the heat generated in the inverter 74a and the AC-DC converter 72 can be sent to an air circulation path 761 (762). Thus, the amount of air containing the heat generated in the inverter 74a and the AC-DC converter 72 at the time of being circulated in the housing 76 can be increased. Consequently, the heat generated in the inverter 74a and the AC-DC converter 72 can be more efficiently transmitted to the lithium ion storage batteries 711.

Although the present invention has been described and illustrated in detail, it is clearly understood that the same is by way of illustration and example only and is not to be taken by way of limitation, the spirit and scope of the present invention being limited only by the terms of the appended claims.

For example, while the photovoltaic power generation modules generate power in each of the aforementioned first and second embodiments, the present invention is not restricted to this, but power generation modules such as other direct current generators or wind turbine generators generating power with another natural energy may be employed as power generation modules.

While the lithium ion storage batteries 711 are employed as the storage portion 71 in each of the aforementioned first and second embodiments, the present invention is not restricted to this, but other secondary batteries may be employed. For example, storage batteries such as nickel-hydrogen storage batteries or lead storage batteries may be employed. Furthermore, capacitors may be employed in place of the storage batteries as an example of the “storage portion” in the present invention.

While the apparatus driven by an alternating-current power source is shown as an example of the specific load 60 in each of the aforementioned first and second embodiments, an apparatus driven by a direct-current power source may be employed. In this case, a DC-DC converter performing DC-DC voltage conversion is employed between the storage portion 71 and the specific load 60 in place of the inverter 74a converting direct current to alternating current. Alternatively, the storage portion 71 and the specific load 60 are directly connected to each other. Furthermore, a direct-current load and an alternating-current load may be mixed as the specific load 60.

While the temperature sensor 78 and the exhaust fan 79 are provided in the storage unit 7 in each of the aforementioned first and second embodiments, the present invention is not restricted to this, but neither the temperature sensor 78 nor the exhaust fan 79 may be provided.

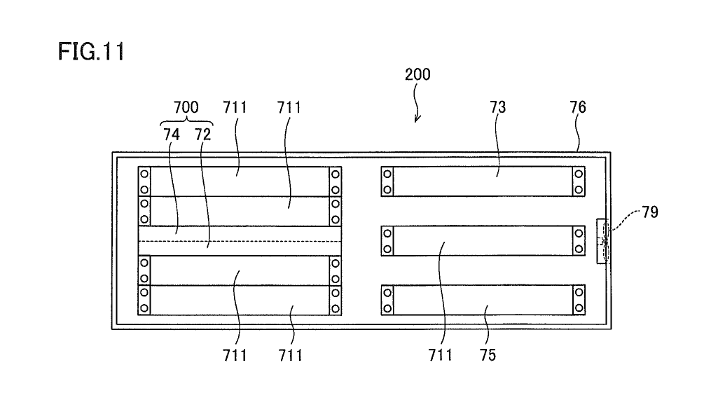

While among the devices, the power conversion unit 700 is arranged in an end of the interior of the housing 76 in each of the aforementioned first and second embodiments, the present invention is not restricted to this, but the arrangement of the power conversion unit 700 may be properly changed. For example, as in a storage unit 200 according to a modification shown in FIG. 11, a power conversion unit 700 may be so arranged as to be surrounded by a plurality of lithium ion storage batteries 711. Thus, the lithium ion storage batteries 711 and the power conversion unit 700 can be arranged close to each other, and hence the lithium ion storage batteries 711 can be more effectively heated by heat exhausted from the power conversion unit 700.

While the heat generated in the power conversion unit 700 is sent to the lower side of the housing 76 by the heat radiation fans 701 provided in the power conversion unit 700 in each of the aforementioned first and second embodiments, the present invention is not restricted to this. In other words, the heat generated in the power conversion unit 700 may be sent to the lower side of the housing 76 by fans provided separately from the power conversion unit 700.

While the lithium ion storage batteries 711, the charge/discharge control box 73, the power conversion unit 700, and the control box 75 are arranged side by side in each of the aforementioned first and second embodiments, the present invention is not restricted to this, but all or some of these devices may be arranged vertically.

While the changeover switches 5 and 6 are provided in each of the aforementioned first and second embodiments, the present invention is not restricted to this, but only either the changeover switch 5 or 6 may be provided, or no changeover switch may be provided.

While the storage unit 7 is placed outdoors in each of the aforementioned first and second embodiments, the present invention is not restricted to this, but the storage unit 7 may be placed indoors. The present invention is more effective in a case where the storage unit 7 is placed in an environment where the air temperature may decrease significantly.

What is claimed is:

1. A storage unit comprising:
a power converter that radiates heat by converting power to direct current or alternating current;
a storage portion that stores power;
a housing that houses at least said storage portion and said power converter;
an air blower provided in said housing; and
a box-shaped power conversion unit that houses said power converter, arranged inside said housing, wherein
said air blower is so configured as to send air inside said power conversion unit into said housing outside said power conversion unit and send air containing heat radiated from said power conversion unit into said housing where said storage portion is arranged.

2. The storage unit according to claim 1, wherein
said storage portion has a property of absorbing heat during charge.

3. The storage unit according to claim 2, wherein
said storage portion is constituted by one or more lithium ion storage batteries.

4. The storage unit according to claim 1, wherein
said air blower is provided on a lower side of said power converter.

5. The storage unit according to claim 4, wherein
said air blower is so configured as to send said air containing said heat radiated from said power converter to an inner lower side of said housing.

6. The storage unit according to claim 1, further comprising a fan that exhausts said heat radiated from said power converter out of said housing.

7. The storage unit according to claim 5, wherein
said housing has a first circulation path, and
said first circulation path is provided in an inner lower portion of said housing, and is so configured as to circulate said air sent to said inner lower side of said housing by said air blower to at least an arrangement position of said storage portion inside said housing.

8. The storage unit according to claim 7, wherein
said housing further has a second circulation path, and
said second circulation path is in communication with said first circulation path, and is so configured as to circulate said air sent by said air blower from an inner lower portion of said housing to an inner upper portion of said housing along a side surface of said storage portion.

9. The storage unit according to claim 1, further comprising a vent provided in an upper portion of said housing.

10. The storage unit according to claim 1, wherein
said power converter includes a first power converter and a second power converter,
said first power converter converts power from a power grid to direct current, and supplies said power converted to direct current to said storage portion or a prescribed load, and
said second power converter is not connected to said power grid, converts said power from said storage portion, and supplies converted said power to said prescribed load.

11. The storage unit according to claim 1, wherein
said power converter includes a first power converter and a second power converter,
said first power converter converts power from a power grid to direct current, and supplies said power converted to direct current to said storage portion or a prescribed direct-current load, and
said second power converter is not connected to said power grid, converts said power from said storage portion to alternating current, and supplies said power converted to alternating current to a prescribed alternating-current load.

12. The storage unit according to claim 10, wherein
said air blower is provided on a lower side of each of said first power converter and said second power converter, and is so configured as to send air containing heat radiated from said first power converter and said second power converter to an inner lower side of said housing.

13. The storage unit according to claim 6, further comprising a first temperature detection portion that detects a temperature in said housing, provided close to said fan in said housing, wherein
said fan exhausts air out of said housing based on a detection result of said first temperature detection portion.

14. The storage unit according to claim 1, further comprising:
a second temperature detection portion that detects a temperature in a vicinity of said power converter, provided in said housing; and
a control portion that controls charge and discharge of said storage portion based on at least a detection result of said second temperature detection portion.

15. A power generation system comprising:
a power generation module that generates power with natural energy, interconnected to a power grid;
a power converter that converts power from said power grid to direct current;
a storage portion that stores at least said power converted to direct current by said power converter;
a housing that houses at least said storage portion and said power converter;
an air blower provided in said housing; and
a box-shaped power conversion unit that houses said power converter, arranged inside said housing, wherein
said air blower is so configured as to send air inside said power conversion unit into said housing outside said power conversion unit and send air containing heat radiated from said power conversion unit into said housing where said storage portion is arranged.
